(19) United States
(12) Patent Application Publication
(10) Pub. No.: US 2005/0261926 A1
(43) Pub. Date: Nov. 24, 2005

(54) System and method for quantifying and communicating a quality of a subject entity between entities

(76) Inventor: Andrew J. Hartridge, University Heights, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/852,464

(22) Filed: May 24, 2004

(51) Int. Cl. G06F 17/60

(52) U.S. Cl. 705/1

(57) ABSTRACT

A system and method for quantifying and communicating a quality of a subject entity between unrelated entities includes the steps of developing a plurality of factors of interest to the requesting entity, each of the factors having a plurality of attributes and each of the attributes having associated therewith a value, providing the factors, attributes and values to an entity asserting the trustworthiness, applying the factors and attributes to the individual such that a selected one of the associated values is assigned to each of the factors, compiling the values to develop a trust assertion value and communicating the trust assertion value to an entity requesting information regarding trustworthiness. The system of the invention may employ a computer network so that such information is transmitted over public networks such as the Internet. In the case where the subject entity is an individual, an advantage of the system and method of the present invention is that personal information derived from a relationship between an individual and the asserting entity may be transmitted to an unrelated requesting entity without violating privacy laws.

### BACKGROUND

The present invention relates to systems and methods for communicating information concerning a subject entity between an asserting entity and a requesting entity and, more particularly, to systems and methods for communicating information regarding the trustworthiness or reliability of a subject entity.

It is often necessary in the services industry, and in particular the financial services industry, to establish a relationship between the provider of a service and a potential customer who is an individual. As a result of the widespread use of communication networks such as the Internet, and the mobility of individuals, service providers often must establish a financial relationship with an individual for whom no personal relationship between the service provider and individual previously existed. In such instances, it is necessary for the service provider to (i) authenticate the identity of the individual and (ii) determine the level of trustworthiness of the individual, especially with respect to that individual's likelihood of fulfilling financial obligations owed to the service provider. With respect to the former activity, there exist many ways to authenticate an individual, such as by requiring that individual to provide identifying information in the form of a Social Security number, a driver's license number and so called “non-wallet” information, such as personal bank account information.

With respect to the latter activity, service providers, including financial institutions, traditionally have relied upon credit bureau reports as a baseline. When possible, that baseline would be augmented with other factors derived from a personal relationship between the service provider and the individual customer. In the case where the service provider is a bank, such additional information might be derived by the relationship between the individual and a bank branch manager of the financial institution.

Accordingly, in order for a service provider to assess the trustworthiness and creditworthiness of an individual, it is desirable for the service provider to avail itself of such personal relationship information. However, currently, such relationship information is not available from third party sources other than the service provider itself as a result of restrictions on communication of nonpublic, personal information about an individual, such as those restrictions imposed by the Gramm-Leach-Bliley Act. Accordingly, there is a need for a system and method for quantifying and communicating trustworthiness of an individual between entities and yet maintain the confidentiality of specific personal relationship information required by law.

There is also a need for a standardized way to evaluate or quantify a level or degree of a quality, such as trust or reliability, of a subject entity.

### SUMMARY

The present invention is a system and method for quantifying and communicating a quality of a subject entity from an asserting entity to a requesting entity without disclosing specific information pertaining to the quality of the subject entity. In a preferred embodiment of the invention, the quality that is quantified is the trustworthiness of an individual. With the method and system of the invention, such a quality is quantified and a value or score representing the level of the quality (i.e., the level of trustworthiness of the subject entity or individual) is communicated between entities without the transmission of nonpublic, personal information that might violate privacy laws and regulations.

The method of the invention includes the steps of developing a plurality of factors of interest to the requesting entity, each of the factors having a plurality of attributes and each of the attributes having associated therewith a different value; communicating the factors, attributes and values to the asserting entity; the asserting entity applying the factors and attributes to the subject entity such that a selected one of the associated values is assigned to each of the factors; the asserting entity then compiling the values to develop a trust assertion value and finally, the asserting entity communicating the trust assertion value to the requesting entity.

In this manner, the requesting entity is able to obtain a value or score that gives an indication of a level or degree of a quality. Thus, in the preferred embodiment, a single value or score that indicates a level or degree of trustworthiness of an individual is transmitted to the requesting party and may be based upon personal and confidential, often relationship-derived, information from an asserting party. Consequently, data representative of personal and confidential information, often relationship-based, may be communicated from a party in possession of the relationship information to an unrelated party who requires such data to evaluate the data without violating laws governing the communication of confidential information, since the data transmitted cannot be “reverse engineered” to determine any specific item of confidential information.

In a preferred embodiment of the invention, the requesting and asserting entities are financial institutions and the requesting entity desires to evaluate the trustworthiness of an individual who has applied for credit but is unknown to the requesting entity. The asserting entity, on the other hand, has a relationship with that individual. Factors of interest in evaluating trustworthiness may include length of relationship, maximum dollar nonrepudiated transaction older than 30 days, number of transactions between the individual and the asserting entity, number of transactions in the immediately preceding three months between the individual and the asserting entity and the level of authentication used for the initial relationship between the individual and the asserting entity. Each of the factors would have associated with it an attribute and a value associated with that attribute. For example, the “length of relationship” factor might have attributes such as: “no relationship” (with a corresponding value of 0), “less than one month” (with a corresponding value of 1), “one to three months” (with a corresponding value of 2), “three to six months” (with a corresponding value of 3), “six months to two years” (with a corresponding value of 4) and “greater than two years” (with a corresponding value of 5).

For the “number of transactions” factor, associated attributes and values may be the following: “no transactions” (assigned a value of 0), “fewer than 10 transactions” (assigned a value of 1), “eleven to fifty transactions” (assigned a value of 2) and “more than fifty transactions” (with a value of 3).

Accordingly, a requesting entity, such as a financial institution, may request a trust assertion value from an asserting entity for a particular individual based upon the aforementioned length-of-relationship factor and number-of-transactions factor. The asserting entity would then examine its personal and confidential relationship with that individual and determine the appropriate attributes for the two factors. For example, if the length of relationship between the asserting entity and individual were three to six months, that factor would be assigned a value of 3 (the value of the associated attribute), and if the number of transactions between the individual and the asserting entity were between eleven and fifty, the value of 2 would be assigned to that factor, resulting in a total score of 5. The asserting entity would then communicate the trust assertion value of 5 (without the underlying bases for its calculation) to the requesting entity. The requesting entity would have established its own criteria for a satisfactory or acceptable trust assertion value. In this example, if the threshold acceptable value were to be set by the requesting entity at 4, the individual would meet the required level of trustworthiness with a trust assertion value of 5.

It is within the scope of the invention to provide a number of factors and a concomitant adjustment in the total trust assertion value. It is also within the scope of the invention to provide values other than numeric values associated with each attribute. For example, values for each attribute could be a letter, such as A, B, C etc. so that the trust assertion value from the preceding analysis might be communicated as “AC.” The requesting institution would evaluate the “AC” rating against its own predetermined threshold of trustworthiness to arrive at a decision. Other values can be assigned as well to the attributes, provided that it would not be possible for the requesting entity to determine an individual score or value for a given attribute, for to do so might violate privacy laws.

The system of the present invention may consist of any standard arrangement of personal computers or mainframe computers between the requesting and asserting entities. Furthermore, the information sent from the requesting entity to the asserting entity and from the asserting entity to the requesting entity may be transmitted by voice, by mail, by private computer network between computer systems or by a public network such as the Internet.

The method and system of the present invention may be applied to communicate a quantified level of reliability between computers, and that reliability may relate to reliability of output of software running on the computer representing the asserting entity. Of course, issues of privacy may not be relevant in such an application, but the benefit of the invention is that it provides a methodology for providing a quantification of a quality of a subject entity, such as a software product.

Accordingly, it is an object of the present invention to provide a system and method for quantifying and communicating a value representative of a quality of a subject entity between unrelated entities; a system and method that communicates data representative of confidential information yet at the same time does not violate privacy laws; a system and method that may be adapted to communicate a value indicative of a level of trustworthiness of an individual that is flexible and can be modified to accommodate a number of factors, including factors relating to a personal relationship between an individual and an entity; and a method and system for communicating trustworthiness, reliability and other qualities that is sufficiently flexible to be used by a variety of institutions in addition to financial institutions.

Other objects and advantages of the present invention will be apparent from the following description, the accompanying drawings and the appended claims.

### BRIEF DESCRIPTION OF THE DRAWINGS

FIG. 1 is a schematic of the architecture of a computer system of the present invention;

FIG. 2 is a flow chart showing the steps of the method of the present invention; and

FIG. 3 is a table showing typical factors, attributes and values of a preferred embodiment of the present invention.

### DETAILED DESCRIPTION

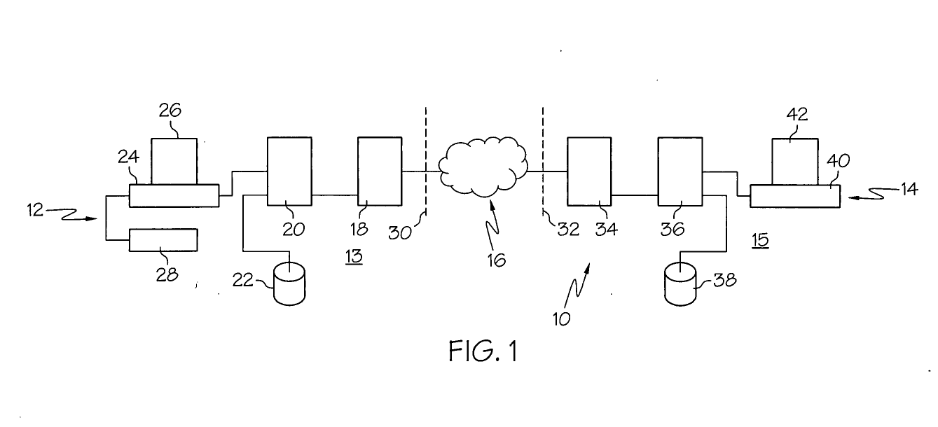

As shown in FIG. 1, a system used for implementing the present invention, generally designated 10, establishes communication between a computer system, generally designated 12, of an entity requesting information 13 and a computer system, generally designated 14, of an entity asserting the information 15. The information to be exchanged is a value or metric that represents a level of a quality of a subject entity.

In a preferred embodiment, the requesting entity 13 may be a first financial institution, the quality may be trustworthiness and the subject entity may be an individual, previously known to the asserting entity 15, who desires to receive financial services from the requesting entity, and the asserting entity 15 may be a second financial institution. Alternatively, the first and second financial institutions may be different lines of business of the same financial institution. In another preferred embodiment, the requesting and asserting entities 13, 15, respectively, may be first and second computer systems, respectively, and the quality may be the reliability of software used by the second computer system. In a third preferred embodiment, the requesting and asserting entities 13, 15, respectively, may be first and second employers, the subject entity may be an employee who had once been employed by the asserting entity and is now being considered for employment by the requesting entity, and the quality may be reliability, trustworthiness, or social skills.

With any of the embodiments, the requesting and asserting entity systems 12, 14 preferably communicate over a network, such as the public network or Internet 16. However, it is within the scope of the invention to utilize a proprietary network, telephone system or other means of transmitting information. The requesting entity system 12 may include a web server 18 that communicates with an application server 20 that, in turn, may communicate with a database 22 for storing information. The application server 20 also may communicate with a terminal or personal computer 24 having a monitor 26 for displaying information received from the asserting entity system 14 and an associated printer 28. The web server 18, application server 20, database 22, personal computer 24 and printer 28 all may be interconnected by a network such as a local area network (LAN) or wide area network (WAN). A firewall 30 is placed between the web server 18 and the Internet 16. Additional firewalls (not shown) may also be employed in the system 12.

Similarly, the asserting entity system 14 includes a firewall 32, web server 34, application server 36 and database 38. The asserting entity system 14 may also include a personal computer or terminal 40 having a display 42. The database 38 may contain personal, nonpublic information pertaining to a relationship between the individual who is the subject of the inquiry by the requesting entity and the asserting entity.

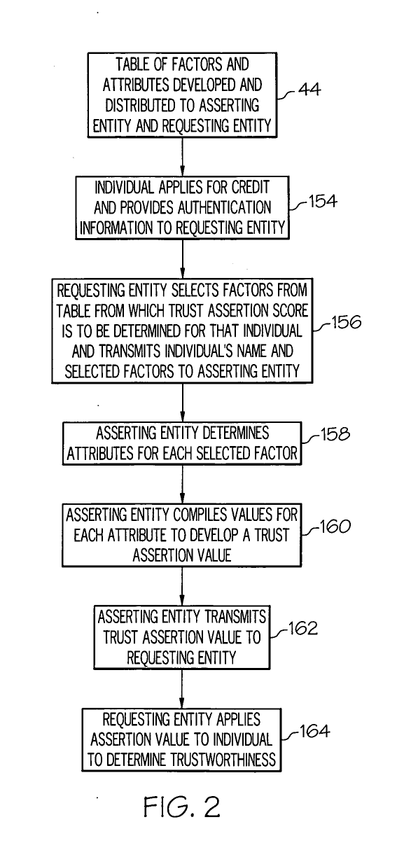

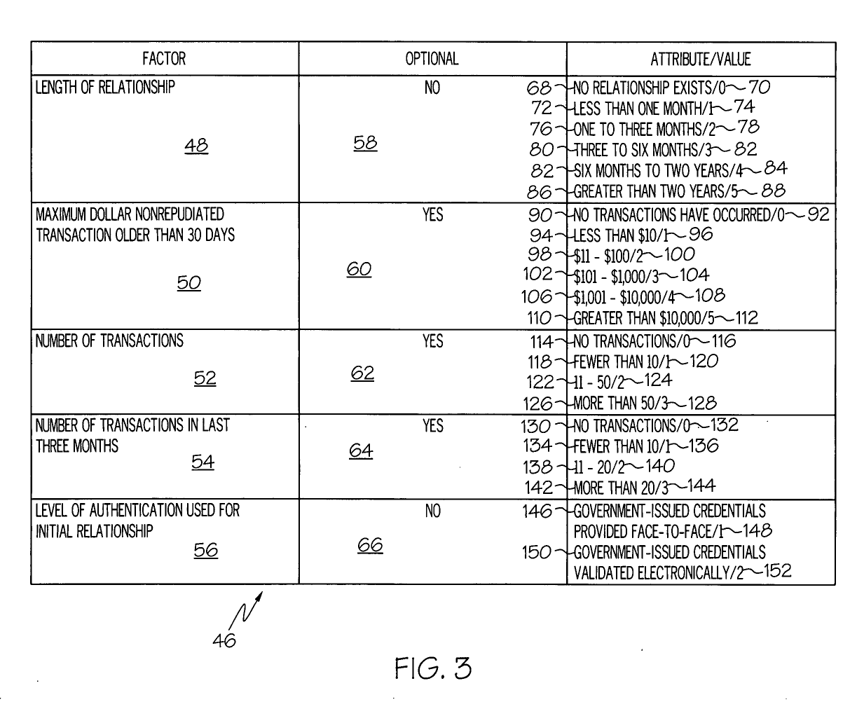

As shown in FIG. 2, the system and method of the present invention includes a multi-step process. The preferred embodiment of the invention is described herein with respect to information in the nature of a quality of a type that may be required by a requesting entity 13 (FIG. 1) in the form of a financial institution and such information would be provided by an asserting entity 15 in the form of a financial institution. Such information may be nonpublic and of a personal, relationship-derived nature that may be based upon a relationship between an individual, who may be applying for financial services from the requesting entity 13, and the asserting entity 15. In this instance, in order to communicate information regarding a quality such as the trustworthiness of the individual based upon such personal information, such personal information must first be quantified and a value derived that is at the same time indicative of a level of trustworthiness of the individual to whom it pertains and does not disclose any specific fact used to derive the quantitative score. Accordingly, as shown in block 44 of FIG. 2, a table of factors and attributes is first developed and distributed to the asserting entity and the requesting entity. An example of such a table is shown in FIG. 3 as table 46. Such a table 46 may be developed by the requesting entity 13, the asserting entity 15 or a third party such as a trade association.

Table 46 includes factors such as “length of relationship” 48, “maximum dollar nonrepudiated transaction older than 30 days” 50, “number of transactions” 52, “number of transactions in the last three months prior to the request” 54 and “level of authentication used for initial relationship” 56. It is within the scope of the invention to provide additional factors, or factors that relate to other aspects of a personal relationship between the individual in question and the asserting entity 15. Each of the factors 48-56 has associated with it a value representing whether that factor is required or optional. For example, the “length of relationship” factor 48 is not considered optional in block 58, “maximum dollar nonrepudiated transaction older than 30 days” factor 50 is considered optional in block 60, “number of transactions” 52 is considered optional as shown in block 62, “number of transactions in last three months” is considered optional as shown in block 64, and “level of authentication used for initial relationship” 56 is listed as not optional in block 66.

Each of the factors 48-56 has associated with it a number of attributes and each of the attributes has a different assigned value. As shown in FIG. 3 in Table 46, “length of relationship” factor 48 has associated with it attribute 68 “no relationship exists” with an assigned value 70 of 0, attribute 72 of “less than one month” with an associated value 74 of 1, attribute 76 of “one to three months” with an associated value 78 of 2, attribute 80 of “three to six months” with an associated value 82 of 3, attribute 82 of “six months to two years” with an associated value 84 of 4 and attribute 86 of “greater than two years” with an associated value 88 of 5.

Factor “maximum dollar nonrepudiated transaction older than 30 days” 50 has associated with it “no transactions have occurred” attribute 90 with an associated value 92 of 0, attribute 94 of “less than $10” with an associated value 96 of 1, attribute 98 of “$11-$100” with an associated value 100 of 2, attribute 102 of “$101-$1,000” and an associated value 104 of 3, attribute 106 of “$1,001-$10,000” with an associated value 108 of 4 and attribute 110 of “greater than $10,000” with an associated value 112 of 5.

“Number of transactions” factor 52 has associated with it an attribute 114 of “no transactions” with an associated value 116 of 0, attribute 118 of “fewer than 10” with an associated value 120 of 1, attribute 122 of “11-50” with an associated value 124 of 2 and attribute 126 of “more than 50” with an associated value 128 of 3. “Number of transactions in the last three months” factor 54 has associated with it attribute 130 of “no transactions” and an associated value 132 of 0, attribute 134 of “fewer than 10” with an associated value 136 of 1, attribute “138 of 11-20” with an associated value 140 of 2 and attribute 142 of “more than 20” with an associated value 144 of 3.

Similarly, “level of authentication used for initial relationship” factor 56 has associated with it attribute 146 of “government-issued credentials provided face-to-face” with a value 148 of 1 and attribute 150 of “government-issued credentials validated electronically” with a value 152 of 2. Table 46 preferably is stored in database 38 and is populated with customer information that may be entered manually at personal computer 40 by a bank employee or such information may be taken from customer database files in database 38 (see FIG. 1).

Referring to FIG. 2, the table of factors 46 discussed in block 44 and shown in FIG. 3 may be created by a trade association, the asserting entity 15 (see FIG. 1) or by the requesting entity 13 and transmitted to the asserting entity. The process of the present invention begins when an individual applies for credit from, and provides authentication information to, the requesting entity 13, as indicated in block 154. As indicated in block 156, once the requesting entity 13 has satisfied itself that the individual is who he purports himself to be, by reviewing the authentication information, the requesting entity selects factors from the table 46 of FIG. 3 from which a trust assertion score is to be determined for that individual, and thereafter transmits the individual's name and selected factors to the asserting entity 15, which in the preferred embodiment may be the financial institution with whom the individual has conducted his routine banking. Such information is transmitted from the application server 20 (see FIG. 1) through web server 18, fire wall 30, Internet 36, asserting entity fire wall 32, asserting entity web server 34 and application server 36.

As indicated in block 158 of FIG. 2, the asserting entity determines the attributes for each selected factor from the table 46 of FIG. 3. For example, if the requested factors were “length of relationship” 48, “maximum dollar nonrepudiated transaction older than 30 days” 50 and “level of authentication used for initial relationship” 56, the asserting entity would review the associated attributes 68, 72, 76, 80, 82, 86, 90, 94, 98,102, 106, 110, 146 and 150. Continuing with the example, if the attribute associated with the “length of relationship factor” 48 were “six months to two years” 82, the associated value 84 of 4 would be recorded. With respect to the “maximum dollar nonrepudiated transaction older than 30 days” factor 50, if appropriate attribute were attribute 106, “$1,001-$10,000,” the value 108 of “4” would be noted. And finally, with the “level of authentication used for initial relationship” factor 56, if the “government-issued credentials provided face-to-face” attribute 146 were appropriate, the value 148 of “1” would be noted, for a total score or trust assertion value of 9. This aspect of the overall process is indicated in block 160 of FIG. 2.

As shown in block 162, in the next step of the process the asserting entity 15 transmits the trust assertion value (9) to the requesting entity. This is accomplished by transmitting the value from the application server 36 of the asserting entity system 14 through the web server 34, fire wall 32, Internet 16, requesting entity fire wall 30, web server 18 and application server 20 of the requesting entity system 12. As shown in block 164 of FIG. 2, in the final step of the process, the requesting entity 13 applies the assertion value (9) to the credit application of the individual to determine the trustworthiness and reliability of the individual. In a preferred embodiment, the requesting entity would have a pre-established minimum trust assertion value (for example, 6) above which the trustworthiness of the individual, as indicated by the quantitative factor transmitted from the asserting entity, would indicate a sufficient level of trustworthiness.

It should be noted in this example that, so long as a single set of factors (i.e., two or more factors) is requested of an individual by the requesting entity 13, resulting in a single trust assertion value returned by the asserting entity 15, it would not be possible for the requesting entity to derive a value for any one factor. Thus, the method of the present invention will not violate applicable privacy laws.

Accordingly, the method and system of the present invention provides a simple mechanism for communicating the trustworthiness of an individual based upon confidential, relationship-related information between two unrelated entities without violating privacy laws. While the form of system and methods herein described constitute preferred embodiments of the invention, it is to be understood that other systems and methods may be employed without departing from the scope of the invention.

1. A method for quantifying trustworthiness of an individual and communicating said trustworthiness from an asserting entity to a requesting entity without disclosing confidential information pertaining to said individual comprising the steps of:
providing a plurality of factors indicative of trustworthiness, each of said factors having a plurality of discrete attributes, and assigning a different value to each of said attributes;
communicating said factors, attributes and values to said asserting entity;
said asserting entity applying said factors and said attributes to said individual such that a selected one of said associated values is assigned to each of said factors;
compiling said values to develop a trust assertion value; and
communicating said trust assertion value to said requesting entity without disclosing to said requesting entity said values assigned to each of said factors.

2. The method of claim 1 wherein said developing step includes the step of said requesting entity developing said plurality of factors.

3. The method of claim 1 wherein said applying step includes the step of said asserting entity applying said factors and said attributes to said individual and determining therefrom a value.

4. The method of claim 1 wherein said applying step includes the step of applying a sufficient number of said factors to said individual such that said requesting entity cannot determine any one of said selected values from said trust assertion value.

5. The method of claim 1 wherein one of said factors includes length of relationship between said asserting entity and said individual.

6. The method of claim 1 wherein one of said factors includes maximum dollar nonrepudiated transaction older than 30 days.

7. The method of claim 1 wherein said step of communicating said trust assertion includes communicating said trust assertion value to said requesting entity without communicating said assigned associated values.

8. The method of claim 1 wherein one of said factors includes number of transactions.

9. The method of claim 1 wherein one of said factors includes number of transactions in last three months.

10. The method of claim 1 wherein one of said factors includes level of authentication used for initial relationship.

11. The method of claim 1 wherein said requesting entity is a financial institution.

12. The method of claim 1 wherein said asserting entity is a financial institution.

13. A method for quantifying trustworthiness of an individual and communicating said trustworthiness from on asserting financial institution to a requesting financial institution without disclosing confidential information pertaining to said individual comprising the steps of:
said requesting financial institution selecting a plurality of factors of interest to said requesting financial institution, each of said factors having a plurality of attributes and each of said attributes having associated therewith a numeric score;
said requesting financial institution communicating said factors, attributes and scores to said asserting financial institution;
said asserting financial institution applying said factors and said attributes to said individual such that a numeric score is determined for each of said factors;
summing said numeric scores to develop a trust assertion score, said numeric scores including a sufficient number of said factors such that said requesting financial institution cannot determine any individual one of said numeric scores; and
communicating said trust assertion score to said requesting financial institution.

14. The method of claim 13 wherein one of said factors includes length of relationship between said asserting entity and said individual.

15. The method of claim 13 wherein one of said factors includes maximum dollar nonrepudiated transaction older than 30 days.

16. The method of claim 13 wherein said step of communicating said trust assertion includes communicating said trust assertion value to said requesting entity without communicating said assigned associated values.

17. The method of claim 13 wherein one of said factors includes number of transactions.

18. The method of claim 13 wherein one of said factors includes number of transactions in last three months.

19. The method of claim 13 wherein one of said factors includes level of authentication used for initial relationship.

20. A method for quantifying a quality of a subject entity and communicating said quantified quality from an asserting entity to a requesting entity without disclosing specific information pertaining to said quality of said subject entity, comprising the steps of:
providing a plurality of factors pertinent to said quality and of interest to said requesting entity, each of said factors having a plurality of discrete attributes, and assigning a different value to each of said attributes;
communicating said factors, attributes and corresponding values to said asserting entity;
said asserting entity applying said factors and said attributes to said subject entity and assigning a selected one of said corresponding values to each of said factors;
compiling said values to develop a quality value; and communicating said quality value to said requesting entity.

21. The method of claim 20 wherein said values are numeric values.

22. The method of claim 20 wherein said quality is trustworthiness of said subject entity.

23. The method of claim 20 wherein said quality is reliability of said subject entity.

24. The method of claim 20 wherein said applying step includes the step of applying a sufficient number of said factors to said subject entity such that said requesting entity cannot determine any one of said selected values from said quality value.

25. The method of claim 20 wherein said step of communicating said quality value includes communicating said quality value to said requesting entity without communicating said corresponding selected values.

26. The method of claim 20 wherein said requesting entity is a financial institution.

27. The method of claim 20 wherein said asserting entity is a financial institution.

28. The method of claim 20 wherein said subject entity is an individual.

29. The method of claim 20 wherein said values are based upon a relationship between said subject individual and said asserting entity.

30. A method for quantifying a quality of a subject entity and communicating said quantified quality from an asserting entity to a requesting entity without disclosing specific information pertaining to said quality of said subject entity, comprising the steps of:
providing a plurality of factors pertinent to said quality and of interest to said requesting entity, each of said factors having a plurality of discrete attributes, and assigning a different numeric value to each of said attributes;
communicating said factors, attributes and corresponding values to said asserting entity;
said asserting entity applying said factors and said attributes to said subject entity and assigning a selected one of said corresponding values to each of said factors;
compiling said values to develop a quality value, said asserting entity applying a sufficient number of said factors to said subject entity such that said requesting entity cannot determine any one of said selected values from said resulting quality value; and
communicating said quality value to said requesting entity.

31. A system for quantifying a quality of a subject entity and communicating said quantified quality from an asserting entity to a requesting entity without disclosing specific information pertaining to said quality of said subject entity, comprising:
developing a plurality of factors pertinent to said quality and of interest to said requesting entity, each of said factors having a plurality of discrete attributes, and assigning a different value to each of said attributes;
a first computer system utilized by said asserting entity, said first computer system being in communication with a database having a table, said table having at least some of said plurality of factors, said attributes corresponding to said factors and said values for each of said attributes;
said first computer system being programmed to develop a quality value derived from an application of said factors and said attributes to said subject entity and assigning a selected one of said corresponding values to each of said factors, and to transmit said quality value to another computer system; and
a second computer system utilized by said requesting entity, said second computer system being connected to receive said quality value of said asserting entity.

32. The system of claim 31 wherein said first computer system is programmed not to transmit said assigned selected ones of said corresponding values to another computer system.

33. The system of claim 32 wherein said first computer system is connected to transmit said quality value to said second computer system.

34. The system of claim 31 wherein said first computer system is adapted to receive said factors from said second computer system to compose said table.

35. The system of claim 31 wherein said first computer system is adapted to receive said table from said second computer system.
